(19) United States
(12) Patent Application Publication
(10) Pub. No.: US 2012/0023806 A1
(43) Pub. Date: Feb. 2, 2012

(54) FISHING TACKLE SWIVEL HAVING A KNURLED OUTER SURFACE

(76) Inventor: Troy Dixon Henry, JR., Morehead City, NC (US)

(21) Appl. No.: 13/190,839

(22) Filed: Jul. 26, 2011

Related U.S. Application Data
(60) Provisional application No. 61/344,460, filed on Jul. 28, 2010.

(51) Int. Cl. A01K 91/04

(52) U.S. Cl. 43/43.1

(57) ABSTRACT

A fishing tackle swivel for attaching a fishing lure to a fishing line. The fishing tackle swivel is provided with posts extending from each of the end of a swivel body. A mechanism, such as one or more ball bearings provided in the interior of the swivel body would allow each of the posts to independently rotate with respect to the swivel body. A second end of each of the posts is attached to separate ring members through which the fishing lure and the fishing line are secured. At least a portion of the exterior surface of the swivel body is roughened, such as being knurled, allowing for ease of handling the swivel body.

### CROSS REFERENCE TO RELATED APPLICATION

This application claims the benefit of U.S. Provisional Patent Application Ser. No. 61/344,460, entitled “TERMINAL TACKLE HAVING A KNURLED SWIVEL”, filed Jul. 28, 2010.

### BACKGROUND OF THE INVENTION

1. Field of the Invention

The present invention is directed to fishing tackle, such as a terminal tackle provided between a fishing line and a fishing lure.

2. Description of the Related Art

The prior art is replete with references directed to fishing tackle devices provided with a swivel body. For example, U.S. Pat. No. 2,466,243 to Johnson describes a swivel body adapted for use with fishing tackle. As described therein, a pair of spindles, each spindle having a first end is inserted into the swivel body. Additionally, a ring is attached to a second end. Both of the first ends of the spindle are in turn connected to a pair of ball bearings allowing each spindle to swivel. One of the rings is attached to a fishing line and the second ring is attached to a fishing lure. Therefore, in use, each of the spindles would be allowed to rotate as the lure moves through the water. Fishing tackles employing ball bearing swivels are illustrated with respect to U.S. Design Pat. No. D549,750 and U.S. Patent Application Publication No. 2007/0031183 to Sim. Additional fishing tackles having ball bearing swivels are illustrated in U.S. Pat. No. 7,513,075 and U.S. Patent Application Publication No. 2009/0255170 to Garber, as well as U.S. Design Pat. No. D456,827 to Butts.

A typical swivel body used with a fishing tackle presently utilized in the fishing industry, as well as described in the aforementioned references is approximately 1/2 inch in length. Therefore, as can be appreciated, due to the relatively small size of the swivel body and the fact that the exterior surface of the swivel is metallic, and since a fisherman's fingers are generally wet when endeavoring to attach the fishing tackle to the fishing line and lure, it becomes quite difficult to attach the fishing tackle to the fishing line and lure. This often results in the fisherman losing a grip on the swivel which would then result in the swivel falling in the water and being lost to the fisherman.

### SUMMARY OF THE INVENTION

It is, therefore, an object of the present invention to provide a fishing tackle having a swivel body, with the exterior surface of the swivel roughened, such as, but not limited to providing a knurled surface on the swivel body to ease attachment of the fishing tackle between a fishing line and a fishing lure.

The present invention is directed to a fishing tackle assembly including a swivel body, the tackle assembly provided between a fishing line and a fishing lure. The ability of the swivel to rotate with respect to the fishing line and the fishing lure makes it possible for the lure to be drawn through a body of water without twisting and tangling the fishing line. This allows for the lure to swim or spin without causing the fishing line to rotate and be tangled in itself. The fishing tackle would generally include a swivel body portion having a hole extending from each end. A post or other fitting would extend from each end of the swivel body. The interior of the body of the swivel would include a device for allowing the post to rotate or swivel. This device would generally include one or more ball bearings provided in the interior of the swivel body and cooperating with at least one of the posts, allowing the post to swivel with respect to one another. Each of the post members extending from the swivel body portion would be provided with a through hole allowing a ring to be provided through the hole. One of the rings would be attached to the fishing line and the other ring would be attached to the fishing lure. This configuration would allow each post member and its ring to rotate with respect to the swivel body portion and each other. The posts and swivel body portion as well as the rings are constructed from a corrosive resistant metallic material. A portion or the entire exterior surface of the swivel body portion is roughened for ease of handling. This roughened portion would generally have a knurled appearance, but need not be limited to a knurled surface.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the fishing tackle swivel having a knurled surface according to the present invention.

FIG. 2 is a perspective view of the fishing tackle swivel having a knurled surface according to the present invention shown from the opposite end to that shown in FIG. 1 and rotated 90°.

FIG. 3 is a side view of the fishing tackle swivel having a knurled surface according to the present invention shown in FIG. 1.

FIG. 4 is a top view of the fishing tackle swivel having a knurled surface according to the present invention shown in FIG. 1.

FIG. 5 is an end view of the fishing tackle swivel having a knurled surface.

FIG. 6 is an opposite end view of the fishing tackle swivel having a knurled surface.

FIG. 7 is a top view of the fishing tackle swivel with a snap loop.

FIG. 8 is a view showing the interior of the fishing tackle swivel shown in FIG. 1.

### DESCRIPTION OF THE PREFERRED EMBODIMENTS

The detailed embodiment of the present invention is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

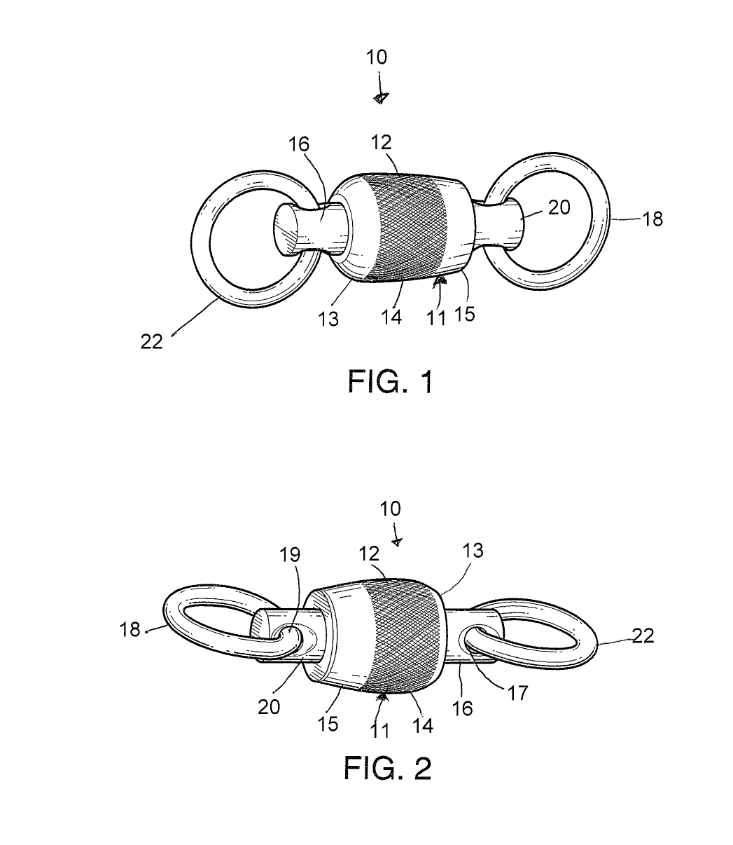

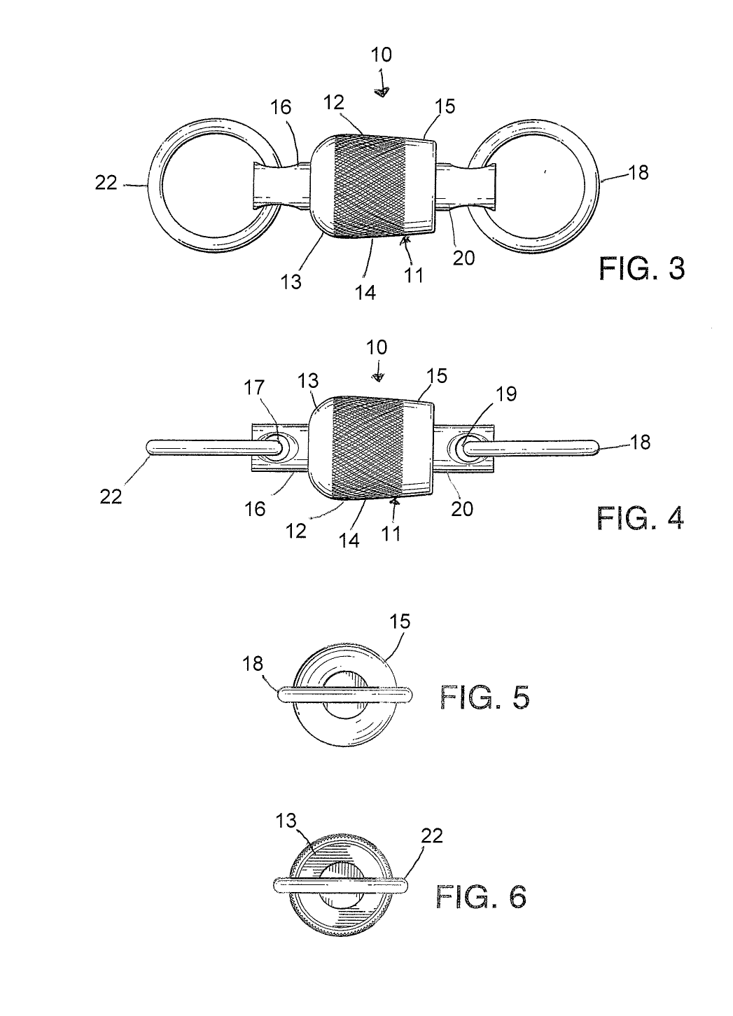

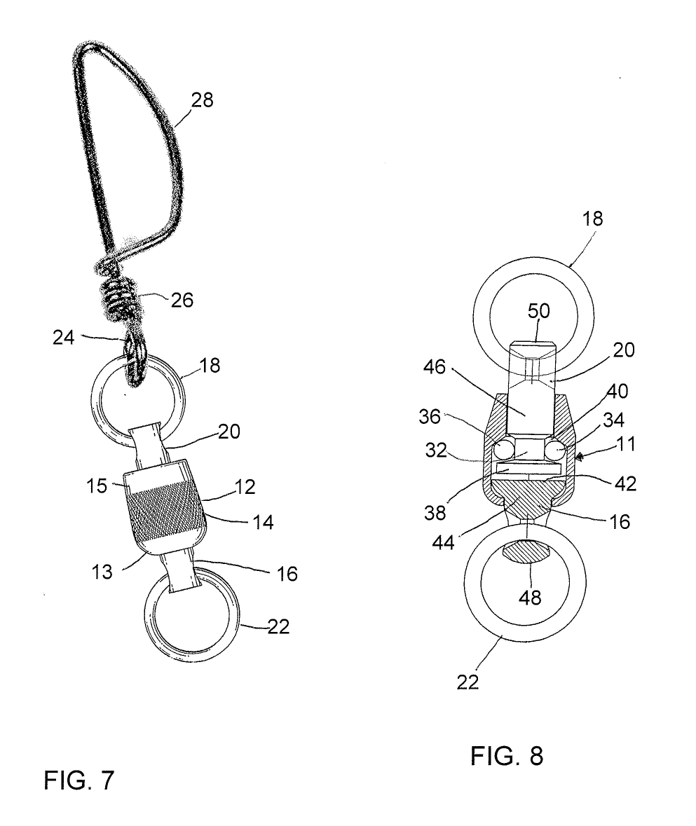

FIGS. 1-8 illustrate the fishing tackle swivel having a knurled outer surface. FIG. 7 illustrates the fishing tackle swivel with a snap loop attached thereto. FIG. 8 shows the interior of the swivel body of the present invention.

Referring back to FIGS. 1-6, a fishing tackle swivel 10 is shown. This fishing tackle swivel 10 includes a generally cylindrical swivel body 11 encompassing a central area 12, a first end area 13 and a second end area 15. It is noted that the first end area 13 is tapered with respect to the central area 12. The second end area 15 is not tapered with respect to the central area 12. As shown particularly in FIGS. 1-4, the exterior surface of the central area 12 has a roughened surface 14. Generally, this roughened surface 14 is knurled but can be roughened in other manners. Furthermore, the exterior surface of the first and second end areas 13, 15 can also be roughened in a similar manner as the central area 12.

As shown in FIG. 8, a first end 44 of a first post member 16 extends through an opening provided in end portion 13. A first end 46 of a second post member 20 extends into the interior of the swivel body 11 through a hole provided in the second end area 15. As will be subsequently described, the interior of the swivel body 11 is provided with a mechanism for allowing both of the post members 16, 20 to independently rotate with respect to one another as well as the swivel body 11.

As illustrated in FIGS. 2, 4 and 8, the post member 16 is provided with a hole 17 extending from a second end 48 of the post member 16 to its second side. Similarly, post member 20 is provided with a hole 19 which extends entirely through a second end 50 of the post member 20. A ring 22 is shown extending through the hole 17 of the post member 16. Similarly, a ring 18 is shown extending through the hole 19 of post member 20.

Since the fishing tackle swivel would be utilized in a relatively harsh environment, the swivel body 11, the post members 16, 20 and the rings 18, 22 shown in all of the drawings are constructed from a non-corrosive metallic material.

In use, a fishing lure would be attached to the ring 18 and the fishing line of a standard fishing rod would be attached to the ring 22 in the manner customary in the fishing art. However, as can be appreciated, the lure can be attached to the ring 22 and the fishing line can be attached to the ring 18.

As illustrated in FIG. 7, a snap loop 28 could be used to attach a lure having a leader thereto. The snap loop 28 includes a series of metallic loops 26 attached thereto which in turn is attached to a ring 24 which in turn is attached to ring 18.

FIG. 8 illustrates a typical mechanism for allowing the posts 16 and 20 to independently rotate with respect to themselves as well as the swivel body 11. The end of the second post member 20 extending into the swivel body 11 includes a portion having a reduced diameter 32 and a flange 38 having a diameter greater than the diameter of portion 32. The interior of the swivel body is provided with a race 40. Ball bearings 34 and 36 are provided between the flange 38 and the race 40 and are each adjacent to the portion 32, allowing the post 20 to rotate when the fishing tackle moves within or on top of a body of water.

As shown in FIG. 8, although no ball bearings are associated with the post 16, this post could also rotate, albeit at a lower rate than post 20 due to the friction between the post 16 and the swivel body 11.

Alternatively, although not shown, a ball bearing can be provided between an end surface 42 of the post 16 and the flange 38 to further facilitate the rotation of post 16. In this instance, a recess would be provided on the surface 42 as well as on the surface of the flange 38 facing the surface 42 to accommodate this ball bearing.

In use, after the fishing lure and fishing line were attached to the fishing tackle swivels shown in FIGS. 1-8, the lures would be cast into the water. The particular construction of the fishing tackle swivels would allow the lure to swim or spin without causing the fishing line to itself rotate.

While the preferred embodiments have been shown and described, it will be understood that there is no intent to limit the invention by such disclosure, but rather, is intended to cover all modifications and alternate constructions falling within the spirit and scope of the invention.

1. A fishing tackle to be used between a fishing line and a fishing lure, comprising:
a swivel body provided with an exterior surface, at least a portion of said exterior surface being roughened to facilitate handling of the fishing tackle;
a first post having a first end provided within said swivel body and connected to a mechanism allowing said first post to rotate with respect to said swivel body, said first post having a second end extending from a first end of said swivel body;
a second post having a first end provided within said swivel body and connected to said second post, wherein said second post rotates with respect to said swivel body, said second post having a second end extending from a second end of said swivel body opposite said first end of said swivel body;
a first means attached to said second end of said first post for attaching said swivel body to the fishing line; and
a second means attached to said second end of said second post for attaching said swivel body to the fishing lure.

2. The fishing tackle in accordance with claim 1, wherein said roughened surface is provided on the entire external surface of said swivel body.

3. The fishing tackle in accordance with claim 1, wherein said roughened surface is knurled.

4. The fishing tackle in accordance with claim 1, wherein said first means comprises a first ring inserted into a hole provided in said second end of said first post, and said second means comprises a second ring inserted into a hole provided in said second end of said second post.

5. The fishing tackle in accordance with claim 1, wherein said first means comprises a first ring inserted into a hole provided in said second end of said first post and said second means comprises a second ring inserted into a hole provided in said second end of said second post and a snap loop attached to said second ring.

6. The fishing tackle in accordance with claim 1, wherein said mechanism consists of at least one ball bearing operatively associated with said first end of said first post.

7. The fishing tackle in accordance with claim 6, wherein the interior of said swivel body is provided with a race and said first end of said first post is provided with a flange, and further wherein said at least one ball bearing is provided between said race and said flange.
